(19) United States
(12) Patent Application Publication
(10) Pub. No.: US 2013/0049422 A1
(43) Pub. Date: Feb. 28, 2013

(54) Chair and Method for Fabricating the Same

(71) Applicants: Kuo-Ching Chou, Tainan City (TW); Ding-Kuo Chou, Tainan City (TW)

(72) Inventors: Kuo-Ching Chou, Tainan City (TW); Ding-Kuo Chou, Tainan City (TW)

(21) Appl. No.: 13/214,275

(22) Filed: Aug. 22, 2011

(51) Int. Cl. A47C 3/00; A47C 7/02; B23P 11/00; A47C 7/54

(52) U.S. Cl. 297/344.12; 29/428

(57) ABSTRACT

A chair and a method for fabricating the chair are provided. Therein, a butterfly mechanism has projecting portions for engaging with receiving recesses formed on a seat frame of the chair, and then the combined butterfly mechanism and seat frame can be fixed by screw members. A tubular portion at the butterfly mechanism is then mounted around a gas lift of a base portion of the chair. Then forward-extending projecting portions formed on a back frame of the chair are engaged with receiving recesses formed correspondingly on the butterfly mechanism, and the back frame and the butterfly mechanism are fixed by using screw members. An inward-extending connecting portion formed at a lower part of each of two armrest supports is inserted into a through hole on the seat frame, and the two components are fixed by using screw members.

### BACKGROUND OF THE INVENTION

1. Technical Field

The present invention relates to chairs, and more particularly to a chair and a method for fabricating the same, wherein components of the chair are configured to be conveniently and accurately aligned and combined with quick screwing operation, so that the chair can be reliably fabricated without using additional tools, and since the screwing operation for combing the components is simplified, the fabricating efficiency of the chair can be improved and the overall processing costs can be reduced

2. Description of Related Art

Conventionally, a chair is made by fabricating numerous components that are mass manufactured. There are mainly two ways to fabricate a chair. The first way, referring to FIG. 1 and FIG. 2, involves positioning a seat frame (10) upside down, properly aligning it with a butterfly mechanism (20), combining the two components (10), (20) by using several screws (60), placing a back frame (30) against the butterfly mechanism (20), combining the two components (20), (30) by using several screws (60), placing left and right armrest supports (40) bilaterally on the seat frame (10), and combining the components (10), (40) by using several screws (60). A semi-product of the chair such fabricated can then be overturned to have a base portion (50) on the seat frame (10) downward combine with an upward-extended gas lift of the base portion (50), thereby completing fabrication of the chair. The foregoing fabrication is nevertheless inconvenient in practice for requiring at least two operators. When the back frame (30) is placed against the butterfly mechanism (20) or when the left and right armrest supports (40) are placed against the seat frame (10), since there is no supporting mechanism to temporarily and stably hold the components in position, it is necessary to have one operator hold the components and then the other operator can successfully combine the components through the screws (60).

The second way involves first positioning the seat frame (10) upside down, properly aligning it with the butterfly mechanism (20), overturning the semi-product of the chair such fabricated, resting the seat frame (10) on the upward-extended gas lift (501) of the base portion (50), placing the back frame (30) against the butterfly mechanism (20), combining the two components (20), (30) by using several screws (60), placing the left and right armrest supports (40) bilaterally on the seat frame (10), and combining the components (10), (40) by using several screws (60), thereby completing fabrication of the chair. Although the foregoing fabrication may be perfumed by one operator, it is also inconvenient in practice. When the back frame (30) is placed against the butterfly mechanism (20) or when the left and right armrest supports (40) are placed against the seat frame (10), since fixing holes of the components for receiving the screws are facing downward, the operator has to put his/her head down and look at the fixing holes upward unless he/she would not be able to accurately install the screws and fix the adjacent components using the screws. As the fixing holes of the components to be aligned and combined are not easily visible, the screwing operation is time-consuming and inconvenient. In the case that the fixing holes of the components are not properly aligned and the combination is not accurate, one of the two components may have its fixing hole being undesirably enlarged, risking the resultant chair with premature unstableness.

### BRIEF SUMMARY OF THE INVENTION

The present invention therefore provides a scheme to improve the conventional chair with the problems in fabrication related to difficulty in aligning fixing holes of the components and inconvenient screwing operation, by configuring a chair's components to be conveniently and accurately aligned and combined with quick screwing operation, thereby allowing the chair to be reliably fabricated without using additional tools. The present invention also simplifies the screwing operation for combing the components, so the fabricating efficiency of the chair can be improved and the overall processing costs can be reduced.

The primary objective of the present invention is to provide a chair including a seat frame, a butterfly mechanism, a back frame, left and right armrest supports, and base portion, and being fabricated by providing the butterfly mechanism with projecting portions for being received in receiving recesses formed at a lower surface of the seat frame, using screw members to fix the butterfly mechanism to the seat frame; overturning a semi-product of the chair such fabricated to a normal, upward position, mounting a tubular portion formed on a lower surface of the butterfly mechanism at a center of gravity of the butterfly mechanism around a gas lift extending from the base portion; engaging a frontward-extended projecting portion formed at a lower end of the back frame with two separated retaining pieces formed on the butterfly mechanism, using screw members to fix the two components; passing an inward-extended connecting portion formed at a lower end of the left or right armrest support through a through hole defined by a pressing bar on the seat frame, abutting a notch provided at one end of the connecting portion against projecting portions formed at the lower surface of the seat frame so that the left and right armrest supports are connected to the lower surface of the seat frame, and using screw members to fix the left and right armrest supports to the seat frame; whereby the components connecting mutually are fixed through screw members so as to form the chair. Therefore, the components of the chair are allowed to be accurately positioned through simple and convenient operation, so fabricating efficiency of the chair is improved and overall processing costs are reduced.

A second objective of the present invention is to provide the chair that the pressing bars that are at the lower surface of the seat frame and adjacent to the receiving recesses and projecting portions for defining the through holes are integratedly formed with the seat frame as a plastic unity through a molding process, in which the seat frame is for the butterfly mechanism and the left and right armrest supports to be attached thereto.

A third objective of the present invention is to provide the chair that the pressing bars that are at the lower surface of the seat frame and adjacent to the receiving recesses and projecting portions for defining the through holes are integratedly formed with the seat frame as a plastic unity through a molding process in which the seat frame is for the butterfly mechanism and the left and right armrest supports to be attached thereto.

A fourth objective of the present invention is to such provide the chair that the pressing bars are made by mounting metal parts on the seat frame that is made through a plastic molding process and fixing the metal parts to the seat frame by means of screws.

A fifth objective of the present invention is to such provide the chair that among the receiving recesses at the lower surface of the seat frame for receiving the butterfly mechanism, the receiving recesses near the front end are covered and the receiving recesses near the rear end are opened, so that the front projecting portions of the butterfly mechanism are positioned after inlaid and then the rear projecting portions extending rearward are directly placed into the corresponding receiving recesses, so that the screw member passing through the two rear projecting portions are fixed to the seat frame.

A sixth objective of the present invention is to such provide the chair that two rearward-extend, separated L-shaped retaining pieces are formed at an upper surface of the butterfly mechanism for combining the back frame, so that after the projecting portion of the back frame extending frontward is inserted, abutting edges adjacent to and below the projecting portion abut against a periphery of the butterfly mechanism to providing a positioning function.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 and FIG. 2 illustrate fabrication of a conventional chair;

FIG. 3 shows a first step for fabricating a chair according to the present invention;

FIG. 4 depicts A Portion of FIG. 3 as an integrated part made from plastic;

FIG. 5 depicts A Portion of FIG. 3 as a part made from metal and covered with plastic;

FIG. 6 depicts A Portion of FIG. 3 made by combining a metal piece to the plastic molded part with screws;

FIG. 7 depicts B Portion of FIG. 3 as an integrated part made from plastic;

FIG. 8 depicts B Portion of FIG. 3 as a part made from metal and covered with plastic;

FIG. 9 depicts B Portion of FIG. 3 made by combining a metal piece to the plastic molded part with screws;

FIG. 10 shows a second step for fabricating the chair of the present invention;

FIG. 11 shows a third step for fabricating the chair of the present invention;

FIG. 12 shows a fourth step for fabricating the chair of the present invention; and

FIG. 13 is an upward perspective view of the assembled chair of the present invention.

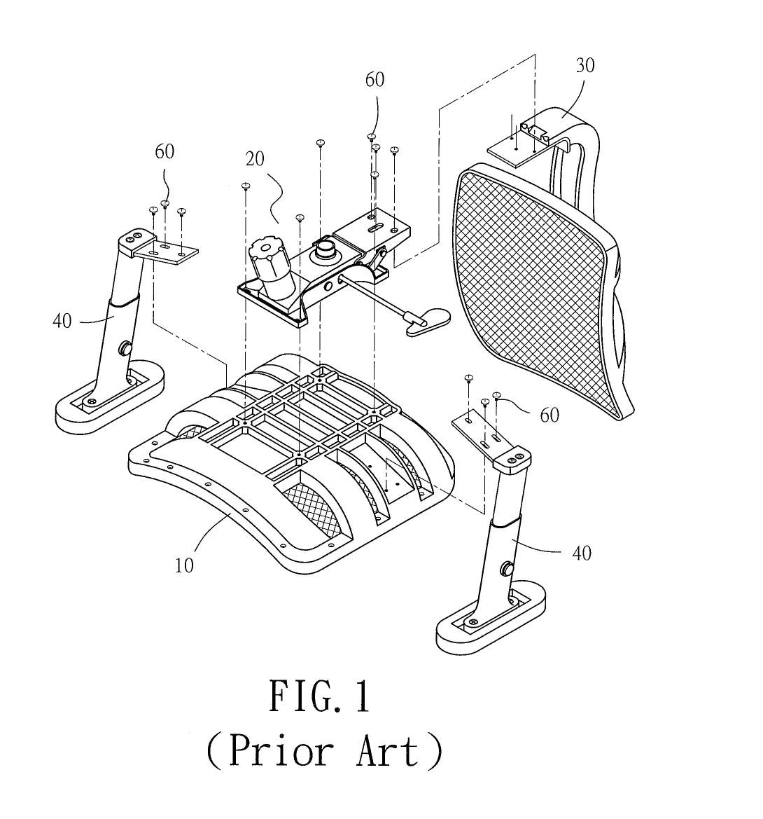

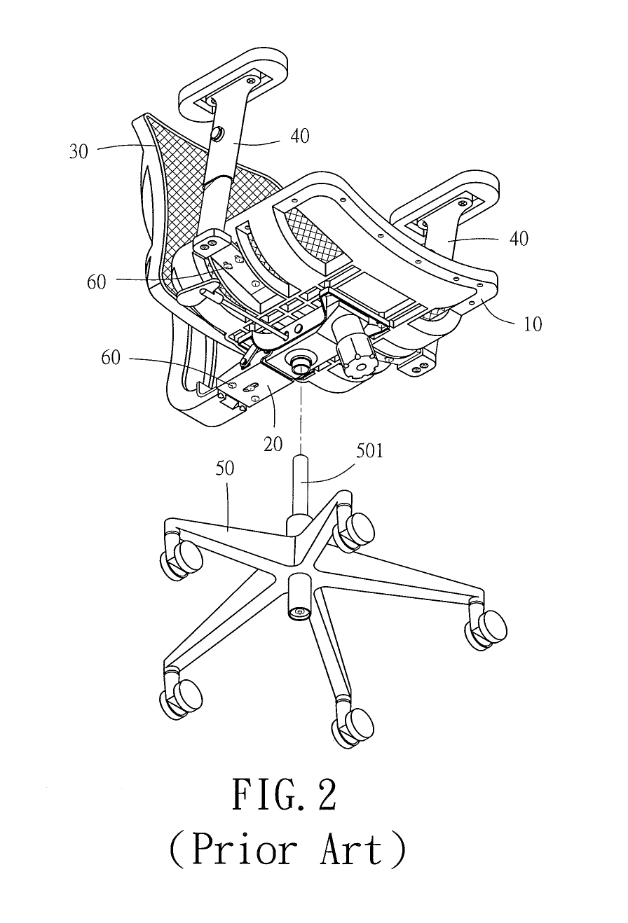

### DETAILED DESCRIPTION OF THE INVENTION

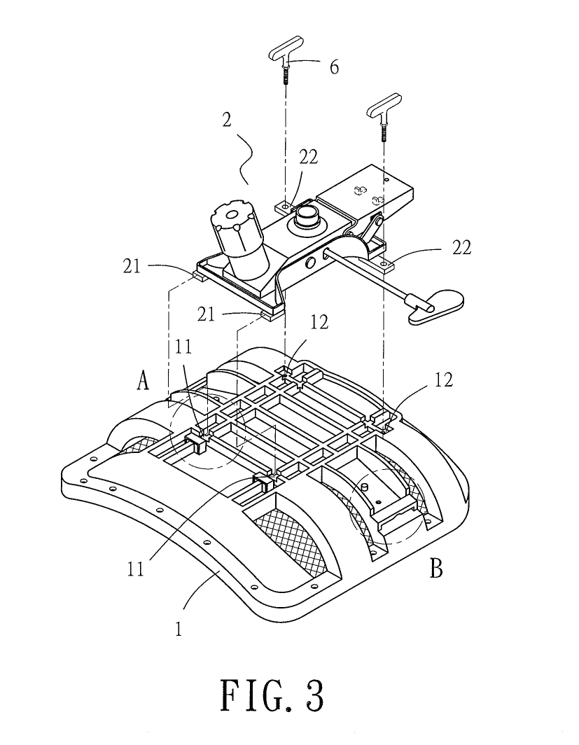

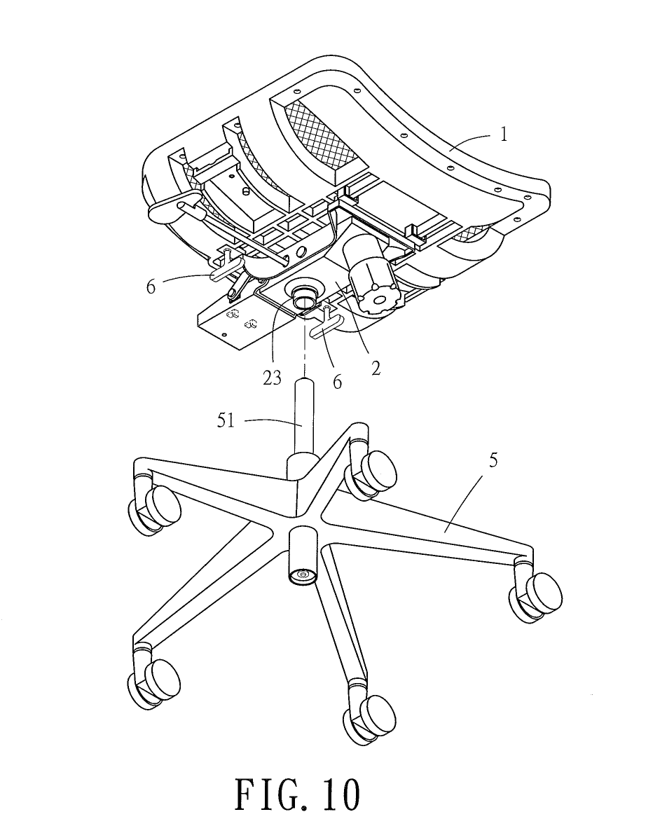

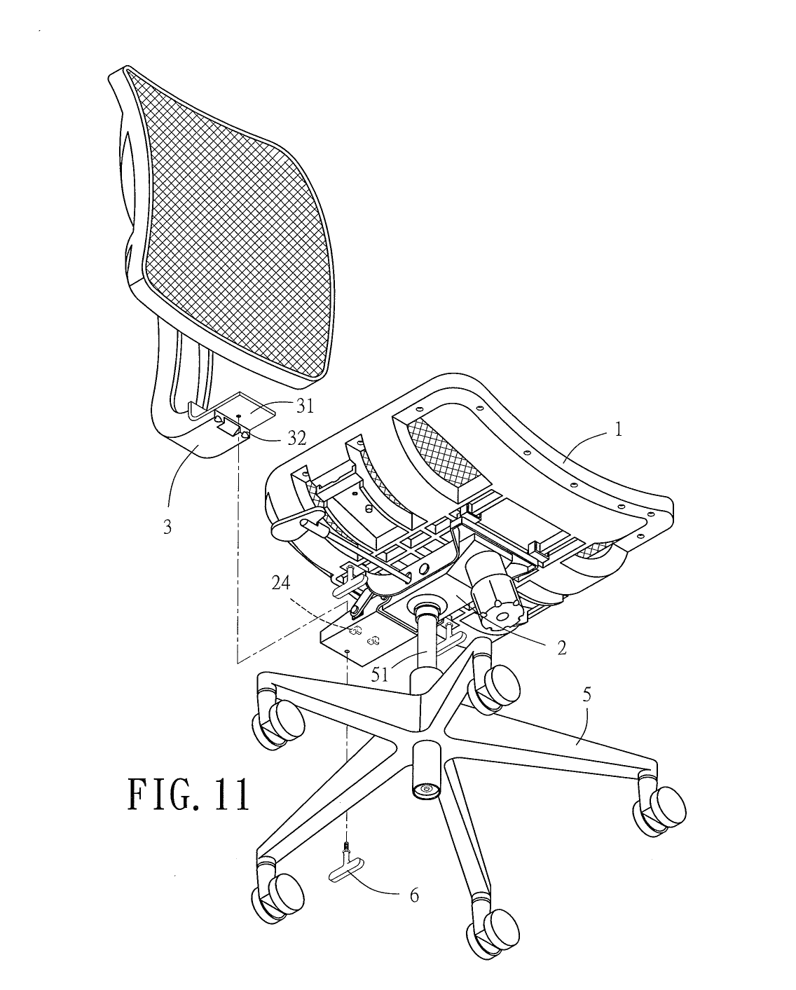

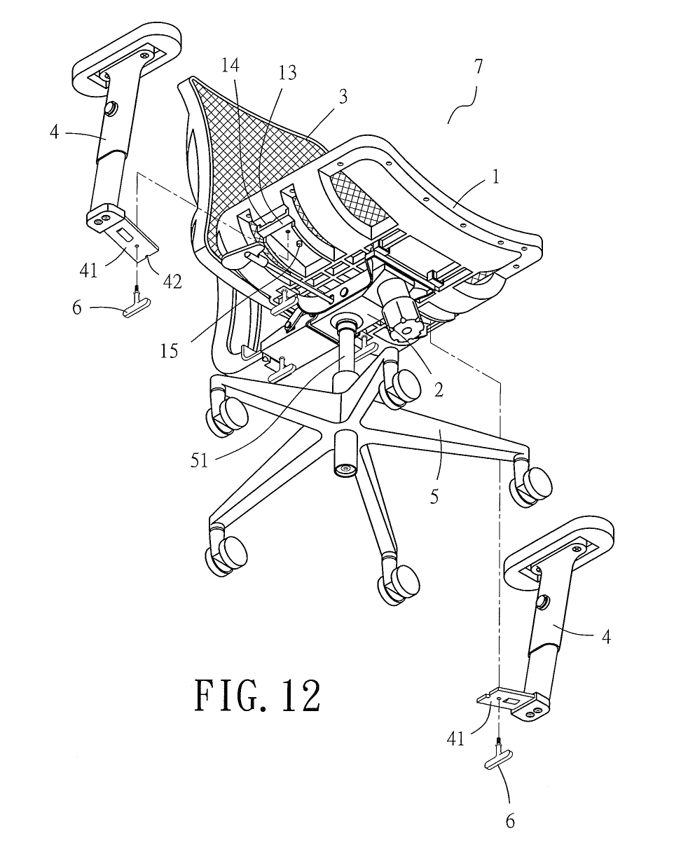

According to the present invention, a chair and a method for fabricating the same are provided. Referring to FIG. 3, FIG. 10, FIG. 11 and FIG. 12, the chair has a seat frame (1), a butterfly mechanism (2), a back frame (3), left and right armrest supports (4), and a base portion (5).

The butterfly mechanism (2) has projecting portions (21, 22) (as shown in FIG. 3) for being received in receiving recesses (11, 12) correspondingly formed at a lower surface of the seat frame (1). Among the receiving recesses (11, 12) formed at the lower surface of the seat frame (1) for positioning the butterfly mechanism (2), the front ones (11) are covered and the rear ones (12) are opened, so that the projecting portions (21) raised from the butterfly mechanism (2) can be inserted and positioned and then the projecting portions (22) extending backward can be placed in the corresponding receiving recesses (12). Afterward, screw members (6) (illustrated by T-shaped bolts in the present embodiment) passing through the two rear projecting portions (22) are screwed and thereby fixed to the seat frame (1).

A semi-product of the chair such fabricated is then overturned to a normal, upward position (as shown in FIG. 10), so that a tubular portion (23) formed on a lower surface at a center of gravity of the butterfly mechanism (2) can be mounted around a gas lift (51) extending upward from the base portion (5). Afterward, a forward-extending projecting portion (31) at a lower end of the back frame (3) is engaged with two retaining pieces (24) formed on the butterfly mechanism (2) with an interval therebetween (as shown in FIG. 11). The butterfly mechanism (2) combined with the back frame (3) has two backward-extending L-shaped retaining pieces (24) formed at an upper surface of the butterfly mechanism (2) with an interval therebetween, so that after the forward-extending projecting portion (31) at the lower end of the back frame (3) is inserted, two abutting edges (32) adjacent to and below the projecting portion (31) can abut against a periphery of the butterfly mechanism (2) and thereby provide a positioning function, and then screw members (6) can be used to fix the two components.

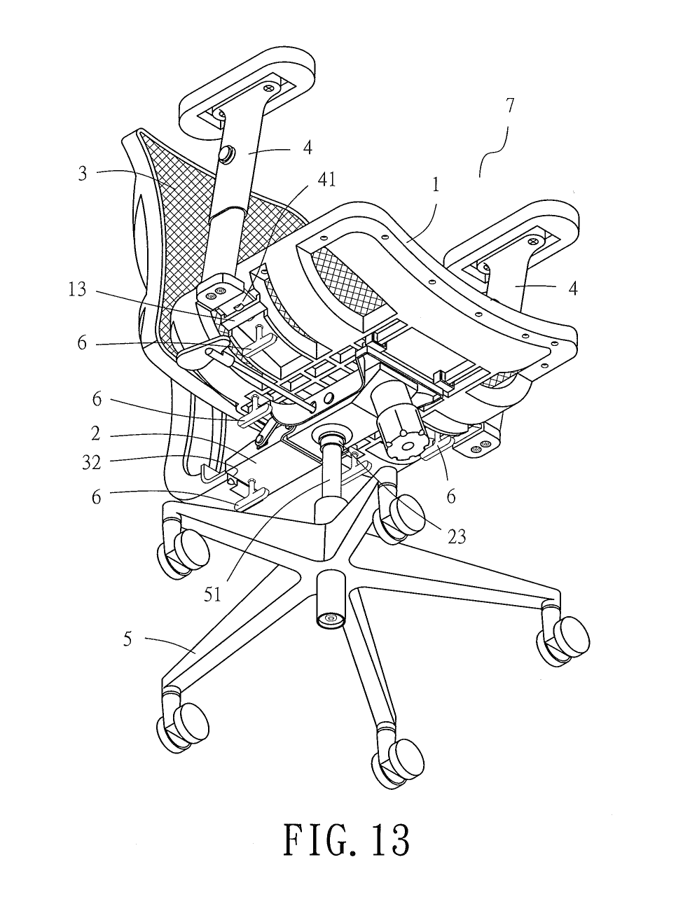

Each of the left and right armrest supports (4) has its lower end formed with an inward-extending connecting portion (41) and the connecting portion (41) is configured to pass through a through hole (14) defined by a pressing bar (13) on the seat frame (1) (as shown in FIG. 12), so that a notch (42) at one end of the connecting portion (41) closely receives a projecting portion (15) formed at the lower surface of the seat frame (1), thereby making the connecting portion (41) positioned adjacent to the lower surface of the seat frame (1). Afterward, screw members (6) are used to fix the left and right armrest supports (4) to the seat frame (1) (as shown in FIG. 13), thereby forming the chair (7). The chair (7) such fabricated with the components accurately positioned through simple and convenient operation, so the fabricating efficiency can be improved and the overall processing costs of the chair (7) can be reduced.

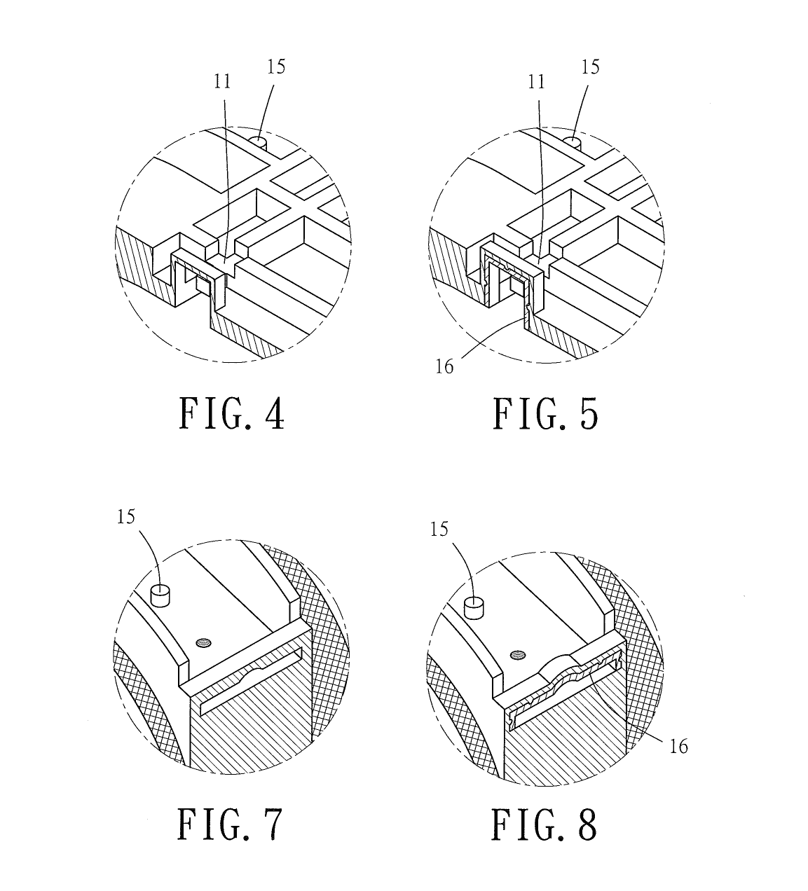

In the chair (7), the pressing bars (13), (as shown in FIG. 12) that are at the lower surface of the seat frame (1) and adjacent to the receiving recesses (11) for defining the through holes (14) are integratedly formed with the seat frame (1) as a plastic unity through a molding process (as shown in FIGS. 4 and 7), or are made by integrating preformed metal parts (16) with the seat frame (1) through a later plastic molding process (as shown in FIGS. 5 and 8). The seat frame (1) is for the butterfly mechanism (2) and the left and right armrest supports (4) to be attached thereto. (as shown in FIG. 5 and FIG. 8).

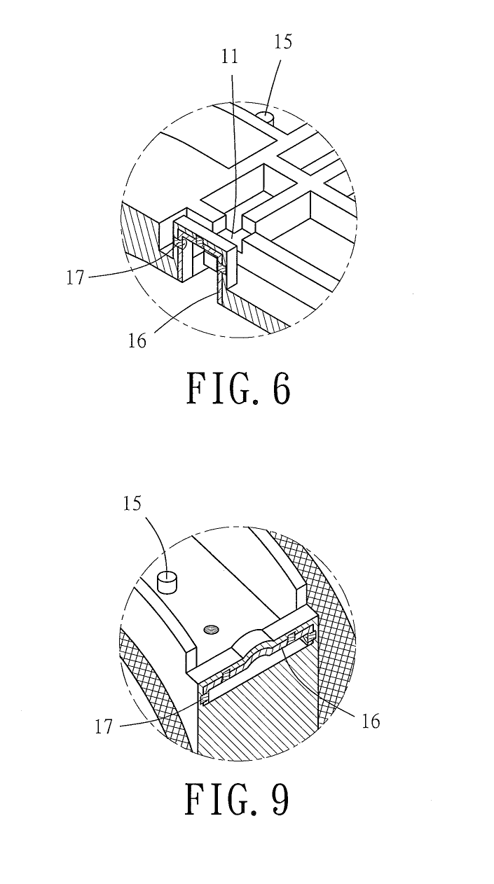

Alternatively, in the chair (7), the projecting portions (15) at the lower surface of the seat frame (1) and the pressing bars (13) for defining the through holes (14) are made by mounting metal parts (16) on the seat frame (1) that is made through a plastic molding process and fixing the metal parts (16) to the seat frame (1) by means of screws (17). (as shown in FIG. 6 and FIG. 9), in which the seat frame (1) is for the left and right armrest supports (4) to be attached thereto.

What is claimed is:

1. A chair, comprising a seat frame, a butterfly mechanism, a back frame, left and right armrest supports, and a base portion;
the seat frame has a lower surface formed with receiving recesses, the receiving recesses near a front end being covered and the receiving recesses near a rear end being opened, two through holes each being defined by a pressing bar at one side of the lower surface of the seat frame, and projecting portions being formed on the lower surface of the seat frame bilaterally having the pressing bars;
the butterfly mechanism having projecting portions, a tubular portion being formed at a center of gravity of the butterfly mechanism, and two rear-extending, separated L-shaped retaining pieces being formed on an upper surface of the butterfly mechanism;
the back frame having a lower end formed with a frontward-extending projecting portion, and the projecting portion extending frontward from the lower end of the back frame having a lower end formed with abutting edges;
the left and right armrest supports, each having a lower end formed with an inward-extended connecting portion, and the connecting portion having one end formed with a notch;
the base portion having a combining end extended with a gas lift;
whereby the components connecting mutually are fixed through screw members so as to form the chair.

2. The chair of claim 1, wherein the pressing bars that are at the lower surface of the seat frame and adjacent to the receiving recesses for defining the through holes are integratedly formed with the seat frame as a plastic unity through a molding process, in which the seat frame is for the butterfly mechanism and the left and right armrest supports to be attached thereto.

3. The chair of claim 1, wherein the pressing bars are made by integrating preformed metal parts with the seat frame through a later plastic molding process, in which the seat frame is for the butterfly mechanism and the left and right armrest supports to be attached thereto.

4. The chair of claim 1, wherein the projecting portions at the lower surface of the seat frame and the pressing bars for defining the through holes are made by mounting metal parts on the seat frame that is made through a plastic molding process and fixing the metal parts to the seat frame by means of screws, in which the seat frame is for the left and right armrest supports to be attached thereto.

5. The chair of claim 1, wherein among the receiving recesses at the lower surface of the seat frame for receiving the butterfly mechanism, the receiving recesses near the front end are covered and the receiving recesses near the rear end are opened, so that the front projecting portions of the butterfly mechanism are positioned after inlaid and then the rear projecting portions extending rearward are directly placed into the corresponding receiving recesses, so that the screw member passing through the two rear projecting portions are fixed to the seat frame.

6. The chair of claim 1, wherein two rearward-extend, separated L-shaped retaining pieces are formed at an upper surface of the butterfly mechanism for combining the back frame, so that after the projecting portion of the back frame extending frontward is inserted, abutting edges adjacent to and below the projecting portion abut against a periphery of the butterfly mechanism to providing a positioning function.

7. A method for fabricating a chair comprising a seat frame, a butterfly mechanism, a back frame, left and right armrest supports, and a base portion;
providing the butterfly mechanism with projecting portions for being received in receiving recesses formed at a lower surface of the seat frame, using screw members to fix the butterfly mechanism to the seat frame; overturning a semi-product of the chair such fabricated to a normal, upward position, mounting a tubular portion formed on a lower surface of the butterfly mechanism at a center of gravity of the butterfly mechanism around a gas lift extending from the base portion;
engaging a frontward-extended projecting portion formed at a lower end of the back frame with two separated retaining pieces formed on the butterfly mechanism, using screw members to fix the two components; passing an inward-extended connecting portion formed at a lower end of the left or right armrest support through a through hole defined by a pressing bar on the seat frame, abutting a notch provided at one end of the connecting portion against projecting portions formed at the lower surface of the seat frame so that the left and right armrest supports are connected to the lower surface of the seat frame, and using screw members to fix the left and right armrest supports to the seat frame;
whereby, the components of the chair are allowed to be accurately positioned through simple and convenient operation, so fabricating efficiency of the chair is improved and overall processing costs are reduced.

8. A method for fabricating a chair comprising a seat frame, a butterfly mechanism, a back frame, left and right armrest supports, and a base portion;
providing the butterfly mechanism with projecting portions for being received in receiving recesses formed at a lower surface of the seat frame, using screw members to fix the butterfly mechanism to the seat frame; overturning a semi-product of the chair such fabricated to a normal, upward position, mounting a tubular portion formed on a lower surface of the butterfly mechanism at a center of gravity of the butterfly mechanism around a gas lift extending from the base portion;
passing an inward-extended connecting portion formed at a lower end of the left or right armrest support through a through hole defined by a pressing bar on the seat frame, abutting a notch provided at one end of the connecting portion against projecting portions formed at the lower surface of the seat frame so that the left and right armrest supports are connected to the lower surface of the seat frame, using screw members to fix the left and right armrest supports to the seat frame; engaging a frontward-extended projecting portion formed at a lower end of the back frame with two separated retaining pieces formed on the butterfly mechanism, and using screw members to fix the two components; and
whereby, the components of the chair are allowed to be accurately positioned through simple and convenient operation, so fabricating efficiency of the chair is improved and overall processing costs are reduced.
